(19) United States
(12) Patent Application Publication
(10) Pub. No.: US 2026/0305909 A1
(43) Pub. Date: Oct. 8, 2026

(54) NEAR-FIELD ANTENNA SYSTEM FOR AN APPLIANCE

(71) Applicant: Haier US Appliance Solutions, Inc., Wilmington, DE (US)

(72) Inventors: Clayton Alexander Epps, Louisville, KY (US); Timothy David Kaiser, Louisville, KY (US)

(21) Appl. No.: 19/098,269

(22) Filed: Apr. 2, 2025

(51) Int. Cl. A47L 15/44; A47L 15/42; A47L 15/50; H01Q 1/22

(52) U.S. Cl. CPC A47L 15/449; A47L 15/4257; A47L 15/50; H01Q 1/22

(57) ABSTRACT

A dispenser assembly includes a body and a near-field power antenna selectively positioned adjacent to the body. The near-field power antenna has a first central axis and a first diameter. The dispenser assembly includes a first plurality of magnets spaced from the first central axis by a first distance. The first distance is at least as great as the first diameter. The dispenser assembly includes a near-field receiver antenna coupled with the body. The near-field receiver antenna has a second central axis and a second diameter. The dispenser assembly includes a second plurality of magnets spaced from the second central axis by a second distance. The second distance is at least as great as the second diameter. The second plurality of magnets operably align with the first plurality of magnets such that the first central axis aligns with the second central axis.

### FIELD OF THE INVENTION

The present subject matter relates generally to dishwashing appliances, and more particularly to dispenser assemblies mounted thereon to supply a wash additive to a washing appliance, for example, dish washing appliances.

### BACKGROUND OF THE INVENTION

Dishwashers or dishwashing appliances generally include a tub that defines a wash compartment. Rack assemblies can be mounted within the wash compartment of the tub for receipt of articles for washing. In a typically known dishwashing appliance, spray assemblies within the wash compartment can apply or direct wash fluid towards articles disposed within the rack assemblies in order to clean such articles. Multiple spray assemblies can be provided including, for example, a lower spray arm assembly mounted to the tub at a bottom of the wash compartment, a mid-level spray arm assembly mounted to one of the rack assemblies, or an upper spray assembly mounted to the tub at a top of the wash compartment.

In order to facilitate cleaning of articles in a dishwashing appliance, cleaning agents or wash additives are used. During operation of the dishwashing appliance, the wash additives generally mix with water in the wash compartment to form a fluid that is used to clean articles within the wash compartment. Wash additives include, for example, detergents and rinse agents. In some cases, liquid wash additives are used.

For some existing appliances, wash additives are stored in one or more reservoirs defined in the doors of dishwashing appliances and are dispensed from these reservoirs during operation of the dishwashing appliance.

Users may tire of pouring detergent into the reservoirs before each operation of the washing appliance. Accordingly, a system that uses a wireless detergent pouring assembly would be advantageous.

As a result, it would be useful to provide a dishwasher appliance or dispenser assembly having features to address one or more of the above issues. In particular, it would be advantageous to provide a wireless attachable dispenser assembly provided within the dishwasher appliance. Additionally, or alternatively, it would be advantageous to provide a dishwasher door and dispensing assembly including bulk storage of wash additive capable of being coupled together while still ensuring a water-tight seal.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a dishwashing appliance includes a tub defining a wash chamber for receipt of articles for washing and a door movable between a closed position and an open position. The appliance includes a dispenser assembly partially mounted to the door within the aperture and partially disposed within the wash chamber. The dispenser assembly includes a near-field power antenna coupled with the door. The near-field power antenna has a first central axis and a first diameter about the first central axis. The dispenser assembly includes a first plurality of magnets spaced from the first central axis of the near-field power antenna by a first distance. The first distance is at least equal to the first diameter of the near-field power antenna. The dispenser assembly includes a near-field receiver antenna coupled with the body. The near-field receiver antenna has a second central axis and a second diameter about the second central axis. The dispenser assembly includes a second plurality of magnets spaced from the second central axis of the near-field receiver antenna by a second distance. The second distance is at least equal to the second diameter of the near-field receiver antenna. The second plurality of magnets operably align with the first plurality of magnets such that the first central axis aligns with the second central axis about a common axis to increase efficiency of a transfer of power from the near-field power antenna to the near-field receiver antenna.

In another exemplary aspect of the present disclosure, a dispenser assembly includes a body and a near-field power antenna selectively positioned adjacent to the body. The near-field power antenna has a first central axis and a first diameter about the first central axis. The dispenser assembly includes a first plurality of magnets spaced from the first central axis of the near-field power antenna by a first distance. The first distance is at least equal to the first diameter of the near-field power antenna. The dispenser assembly includes a near-field receiver antenna coupled with the body. The near-field receiver antenna has a second central axis and a second diameter about the second central axis. The dispenser assembly includes a second plurality of magnets spaced from the second central axis of the near-field receiver antenna by a second distance. The second distance is at least equal to the second diameter of the near-field receiver antenna. The second plurality of magnets operably align with the first plurality of magnets such that the first central axis aligns with the second central axis about a common axis to increase efficiency of a transfer of power from the near-field power antenna to the near-field receiver antenna.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of an example dishwashing appliance according to one or more embodiments of the present disclosure.

FIG. 2 provides a side, section view of the example dishwashing appliance of FIG. 1.

FIG. 3 provides a schematic view of a near-field power antenna aligning with a near-field receiver antenna.

FIG. 4 provides a top perspective view of a door of the example dishwashing appliance of FIG. 1

FIG. 5 provides a front view of an example dispenser assembly according to one or more embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “generally,” “approximately,” and “substantially,” are not to be limited to the precise value specified. In at least some instances, the approximating language may correspond to the precision of an instrument for measuring the value. For example, the approximating language may refer to being within a 10 percent margin.

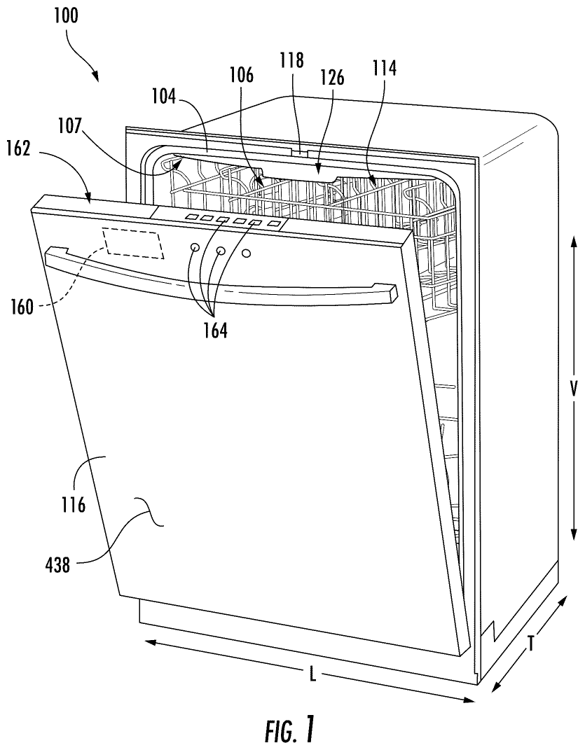

As used herein, the terms “first,” “second,” and “third” may be used interchangeably to distinguish one component from another and are not intended to signify location or importance of the individual components. Terms such as “inner” and “outer” refer to relative directions with respect to the interior and exterior of the appliance. For example, “inner” or “inward” refers to the direction towards the interior of the appliance. Terms such as “left,” “right,” “front,” “back,” “top,” or “bottom” are used with reference to the perspective of the dishwasher appliance as illustrated in FIG. 1. For example, a user faces a front of the dishwasher appliance to place articles through a front of the dishwasher appliance.

Referring now to the drawings, FIG. 1 illustrates a perspective view of one embodiment of a dishwasher appliance 100 in accordance with aspects of the present subject matter. It should be appreciated that, although the dishwasher appliance 100 illustrated herein may generally correspond to any suitable dishwasher appliance such as a domestic or commercial dishwasher appliance.

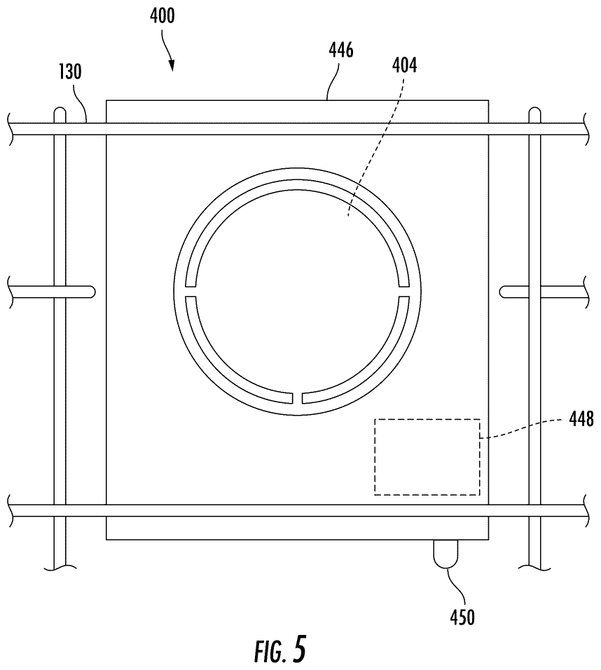

With reference to FIGS. 1 through 3, the transverse direction, denoted by the arrow labeled “T,” corresponds to the axis along which terms such as “front” and “back” are oriented. The vertical direction, indicated by the arrow labeled “V,” aligns with the axis associated with terms such as “top” and “bottom.” The lateral direction, represented by the arrow labeled “L,” defines the axis along which terms such as “left” and “right” are referenced. These directional conventions provide a standardized framework for the spatial orientation of the dishwasher appliance 100 described herein and among FIGS. 1 through 5.

It should be appreciated that where a value is at a threshold, one skilled in the art may determine whether an action at the threshold may correspond to actions below the threshold or above the threshold. For instance, an action “below a threshold” may include values “at or below a threshold”. In another instance, an action “above a threshold” may include values “at or above a threshold”. One skilled in the art may alter the corresponding action of a value at or equal to a threshold without deviating from the scope of the present disclosure.

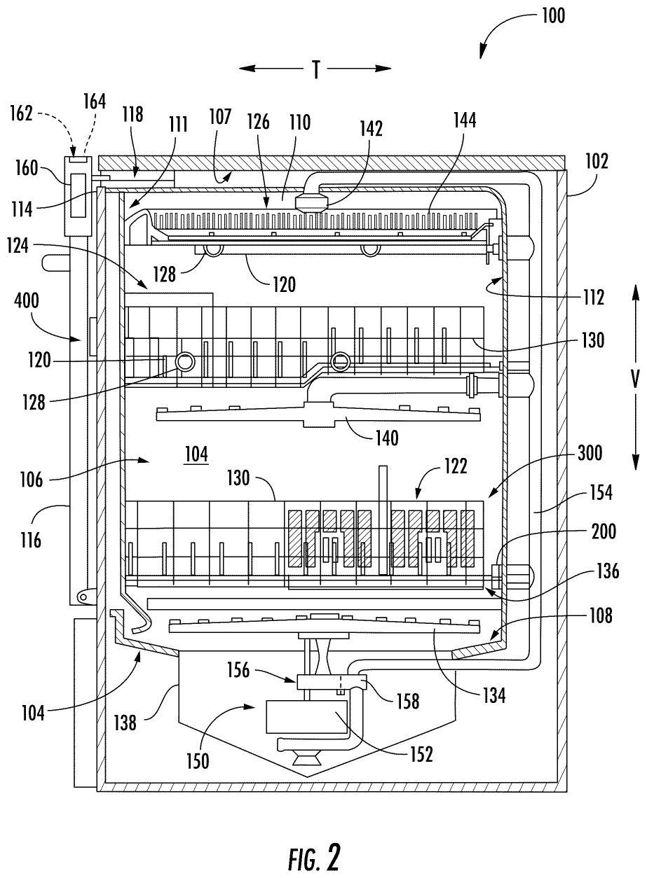

FIGS. 1 through 5 illustrate an example embodiment of a domestic dishwasher appliance 100. Specifically, FIGS. 1 and 2 illustrate perspective views of dishwasher appliance 100 in an open position and a closed position, respectively. FIG. 2 further provides a side cross-sectional view of the dishwasher appliance 100. The dishwasher appliance 100 generally defines a vertical direction V, a lateral direction L, and a transverse direction T, each of which is mutually perpendicular, such that an orthogonal coordinate system is generally defined.

Turning now to the figures, FIGS. 1 and 2 illustrate a domestic dishwashing appliance 100, or dishwasher appliance, according to example embodiments of the present disclosure. As shown in FIGS. 1 and 2, the dishwashing appliance 100 may include a cabinet 102 having a tub 104 therein defining a wash chamber 106. The tub 104 may generally include a front opening and a door 116 hinged at its bottom for rotatable movement between a closed or vertical position (shown in FIGS. 1 and 2), wherein wash chamber 106 is sealed shut for washing operation and access to wash chamber 106 is restricted, and a horizontal open position for loading and unloading of articles from the dishwashing appliance 100. A latch (not shown) may be used to lock and unlock the door 116 for access to the chamber 106 through an opening 114.

Generally, cabinet 102 may define a discrete vertical direction V, lateral direction L, and transverse direction T. Vertical direction V, lateral direction L, and transverse direction T are mutually perpendicular such that vertical direction V, lateral direction L, and transverse direction T form an orthogonal directional system.

As is understood, the tub 104 may generally have a rectangular cross-section defined by various wall panels or walls. For example, as shown in FIG. 2, the tub 104 may include a top wall 107 and the bottom wall 108 spaced apart from one another along a vertical direction V of the dishwashing appliance 100. Additionally, the tub 104 may include a plurality of sidewalls 110 (e.g., three sidewalls) extending between the top and bottom walls 107, 108. It should be appreciated that the tub 104 may generally be formed from any suitable material. However, in optional embodiments, the tub 104 may be formed from a ferritic material, such as stainless steel, or a polymeric material, such as high-density polyurethane.

As particularly shown in FIG. 2, guide rails 120 may be mounted on opposing sidewalls 110 of the tub 104 and may be configured to accommodate roller-equipped rack assemblies 122, 124, and 126. Each of the rack assemblies 122, 124, and 126 may be fabricated into lattice structures including a plurality of elongated members 130 (for clarity of illustration, not all elongated members making up rack assemblies 122, 124, or 126 are shown in FIG. 2). Additionally, each rack 122, 124, and 126 may be adapted for movement between an extended loading position (not shown) in which the rack 122, 124, 126 is substantially positioned outside wash chamber 106, and a retracted position (shown in FIGS. 1 and 2) in which the rack 122, 124, or 126 is located inside wash chamber 106. This may be facilitated by rollers 128, for example, mounted onto racks 122, 124, and 126, respectively.

In some embodiments, a silverware basket 300 is removably mounted to lower rack assembly 122. However, in alternative exemplary embodiments, the silverware basket 300 may also be selectively attached to other portions of dishwashing appliance 100 (e.g., door 116). The silverware basket 300 defines one or more storage chambers and is generally configured to receive silverware, flatware, utensils, and the like, that are too small to be accommodated by the upper and lower rack assemblies 122, 124, and 126. The silverware basket 300 may be constructed of any suitable material (e.g., metal or plastic) and define a plurality of fluid slots for permitting wash fluid therethrough.

The dishwashing appliance 100 includes one or more spray assemblies housed within wash chamber 106. For instance, the dishwashing appliance 100 may include a lower spray-arm assembly 134 that is rotatably mounted within a lower region 136 of wash chamber 106 directly above the bottom wall 108 of the tub 104 so as to rotate in relatively close proximity to the rack assembly 122. As shown in FIG. 2, a mid-level spray-arm assembly 150 may be located in an upper region of wash chamber 106, such as by being located in close proximity to the upper rack 126. Moreover, an upper spray assembly 142 may be located above the upper rack 126.

As is generally understood, the lower and mid-level spray-arm assemblies 134, 140 and the upper spray assembly 142 may generally form part of a fluid circulation assembly 150 for circulating fluid (e.g., water and dishwasher fluid) within the tub 104. As shown in FIG. 2, the fluid circulation assembly 150 may also include a pump 152 located in a machinery compartment located below the bottom wall 108 of the tub 104. One or all of the spray assemblies 134, 140, 142 may be in fluid communication with the pump 152 (e.g., to receive a pressurized wash fluid therefrom). Additionally, each spray-arm assembly 134, 140, 142 may include an arrangement of discharge ports or orifices for directing washing liquid onto dishes or other articles located in rack assemblies 122, 124, and 126, which may provide a rotational force by virtue of washing fluid flowing through the discharge ports. The resultant rotation of the lower spray-arm assembly 134 provides coverage of dishes and other dishwasher contents with a spray (e.g., a spray of washing fluid).

It should be appreciated that, although the dishwashing appliance 100 will generally be described herein as including three spray assemblies 134, 140, 142, the dishwashing appliance may, in alternative embodiments, include any other number of spray assemblies, including two spray assemblies, four spray assemblies or five or more spray assemblies. For instance, in addition to the lower and mid-level spray-arm assemblies 134, 140 and the upper spray assembly 142 (or as an alternative thereto), the dishwashing appliance 100 may include one or more other spray assemblies or wash zones for distributing fluid within wash chamber 106.

The dishwashing appliance 100 may be further equipped with a controller 160 configured to regulate operation of the dishwasher 100. The controller 160 may generally include one or more memory devices and one or more microprocessors, such as one or more general or special purpose microprocessors operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 160 may be positioned in a variety of locations throughout dishwashing appliance 100. In the illustrated embodiment, the controller 160 is located within a control panel area 162 of the door 116, as shown in FIG. 1. In some such embodiments, input/output (“I/O”) signals are routed between the control system and various operational components of dishwashing appliance 100 along wiring harnesses that may be routed through the bottom of the door 116. Typically, the controller 160 includes a user interface panel/controls 164 through which a user may select various operational features and modes and monitor progress of the dishwasher 100. In one embodiment, the user interface 164 may represent a general purpose I/O (“GPIO”) device or functional block. Additionally, the user interface 164 may include input components, such as one or more of a variety of electrical, mechanical or electro-mechanical input devices including rotary dials, push buttons, and touch pads. The user interface 164 may also include a display component, such as a digital or analog display device designed to provide operational feedback to a user. The user interface 164 may be in communication with the controller 160 via one or more signal lines or shared communication busses.

Additionally or alternatively, as shown in FIG. 2, a portion of the bottom wall 108 of the tub 104 may be configured as a tub sump portion that is configured to accommodate one or more components of the fluid recirculation assembly 150 (e.g., a filter assembly or other components). It should be appreciated that, in several embodiments, the bottom wall 108 of the tub 104 may be formed as a single, unitary component such that the tub sump portion as well as the surrounding portions of the bottom wall 108 are formed integrally with one another. Alternatively, the tub sump portion may be configured as a separate component configured to be attached to the remaining portion(s) of the bottom wall 108.

Optionally, as shown in FIG. 2, the fluid recirculation assembly 150 may also include a diverter assembly 156 in fluid communication with the pump 152 for diverting fluid between one or more of the spray-arm assemblies 134, 140, 142. For example, the diverter assembly 156 may, in several embodiments, is fluidly coupled to the pump 152 (e.g., via a pump conduit (not labeled)) for directing fluid into the diverter assembly 156 and one or more outlets for directing the fluid received from the pump 152 to the lower spray-arm assembly 134 or the mid-level and upper spray-arm assemblies 140, 142, respectively.

It should be appreciated that the present subject matter is not limited to any particular style, model, or configuration of dishwashing appliance. The exemplary embodiments depicted in FIGS. 1 and 2 are simply provided for illustrative purposes only. For example, different locations may be provided for the user interface 164, different configurations may be provided for the racks 122, 124, 126, and other differences may be applied as well.

Referring now to FIGS. 1 through 3, an interior of door 116 is shown. For instance, door 116 may include an inner panel 444, or inner surface, and an outer panel 438. It should be understood that as described below, references to the vertical, lateral, and transverse directions (e.g., defined by door 116) are made with respect to the door 116 being in the closed position (e.g., as illustrated in FIG. 2). Moreover, inner panel 444 generally faces wash chamber 106 while outer panel 438 faces the ambient environment. Inner panel 444 and outer panel 438 may be formed of different materials or, alternatively, the same material. In certain embodiments, inner panel 444 is or includes a polymer material (i.e., is formed from a polymer material), such those including polypropylene. In additional or alternative embodiments, outer panel 438 is or includes a metal or glass material (i.e., is formed from a metal or glass material).

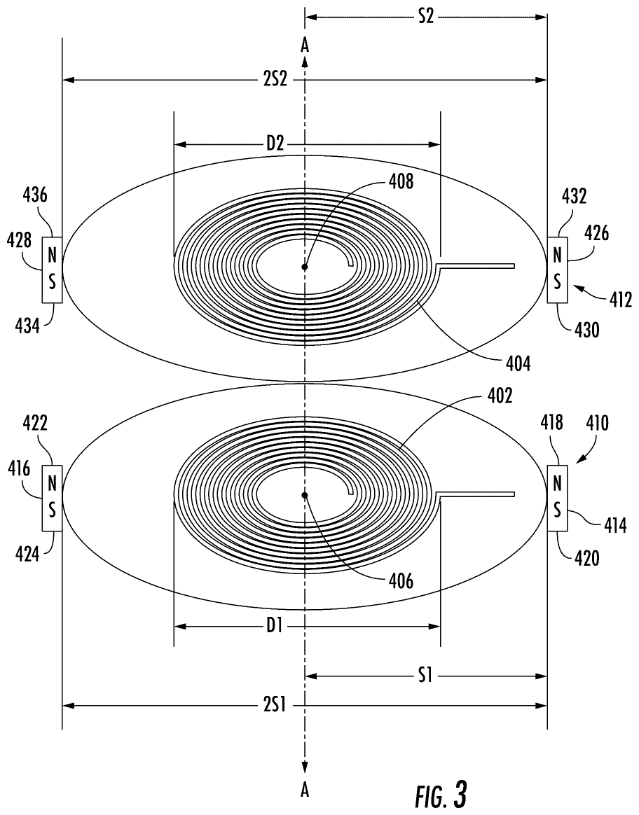

With refence to FIGS. 3 through 5, a dispenser assembly 400 is provided at or at least partially coupled with an inner panel 444 of door 116. Some purposes for the dispenser assembly 400 are to receive and dispense the wash fluid (e.g., liquid, powder, or pod cleaning agent) to the wash chamber 106. In particular, dispensing assembly 400 may be at least partially attached to the inner panel 444 of the door 116. At least two portions of the dispenser assembly 400 may include a near-field power antenna 402 that generally charges a near-field receiver antenna 404.

The near-field power antenna 402 is coupled with the door 116. More specifically, the near-field power antenna 402 is positioned proximal to the inner panel 444 of the door 116. The near-field power antenna 402 is communicatively coupled with the controller 160. The near-field power antenna 402 may include, for example, a generally planar, spiral-shaped conductive coil on a printed circuit board (PCB) or flexible substrate. The conductive coil may include, for example, copper or other highly conductive material. The near-field power antenna 402 is connected to a power source (e.g., an AC power source (not shown)) that generates an oscillating magnetic field.

The near-field power antenna 402 that is generally planar and spiral-shaped has a first central axis 406. The near-field power antenna 402 has a first diameter D1 centered at the first central axis 406. The oscillating magnetic field generated by the near-field power antenna 402 may extend radially from the first central axis 406 by a first distance S1. The first distance S1 may be more than the first diameter D1. In other words, the first distance S1 is at least equal to the first diameter D1 of the near-field power antenna 402.

The near-field power antenna 402 includes a first plurality of magnets 410. The first plurality of magnets 410 may include a first magnet 414 and a second magnet 416. The first magnet 414 may be spaced from the second magnet 416 by at least twice the first distance S1. Additionally, or alternatively, the first magnet 414 may be spaced from the second magnet 416 across the first central axis by about 180 degrees. Therefore, the first magnet 414 may be about diametrically opposite of the second magnet 416 about the first central axis 406 of the near-field power antenna 402.

Each magnet of the first plurality of magnets 410 (e.g., the first magnet 414 and the second magnet 416) has a north end and a south end. For example, the first magnet 414 has a first north end 418 and a first south end 420. The second magnet 416 has a second north end 422 and a second south end 424. Like ends repel and non-like ends attract (e.g., a north end repels a different north end and a north end attracts a south end).

The door 116 may define an aperture 440 configured to house the near-field antenna 402. The aperture 440 may be similarly shaped (e.g., circularly) to the near-field antenna 402. Therefore, the aperture 440 may have a third diameter (not labeled). The aperture 440 may be sized to house the near-field antenna 402 flush within the door 116. Additionally, or alternatively, the aperture 440 may be sized such that near-field antenna 402 is spaced from the door 116 within the aperture 440 by more than about two times the first diameter D1 of the near-field antenna 402.

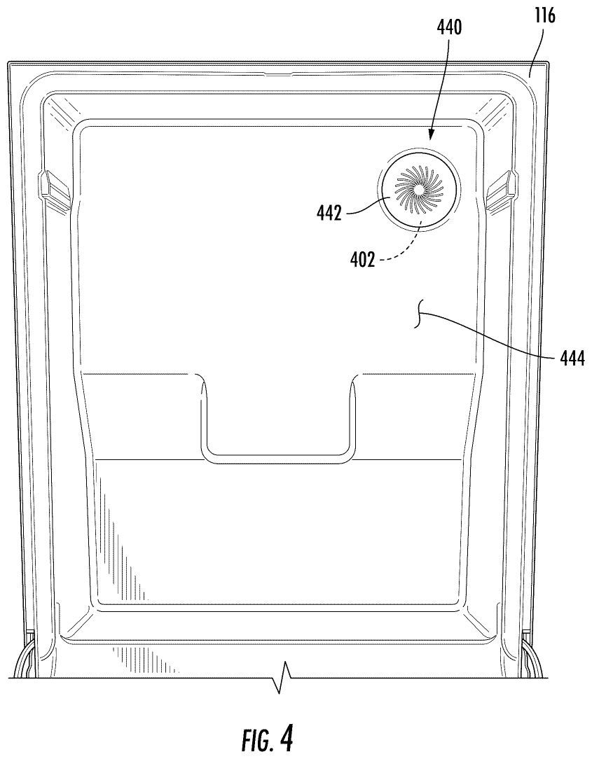

The near-field power antenna 402 may be sealed within the aperture 440 by a cover 442 coupled with the door 116 at the aperture 440. The cover 442, as illustrated in FIG. 4, may be generally circular; therefore, the cover 442 may have a fourth diameter (not labeled). The cover 442 may fit flush within or over the aperture 440 such that the aperture 440 is fluidly sealed to prevent liquids from entering the aperture 440. The cover 442 may be made from a polymeric material, a glass material, or other similar material that allows magnetic fields generated by the near-field power antenna 402 to penetrate through the cover 442.

The dispenser assembly 400 also includes a body 446 that may be coupled with, for example, a rack assembly (e.g., the middle rack assembly 124) at the elongated member 130. Additionally, or alternatively, the body 446 may be slidably coupled with the elongated member 130.

The dispenser assembly 400 further includes the near-field receiver antenna 404 that is selectively charged, or powered, by the near-field power antenna 402 via the oscillating magnetic field generated by the near-field power antenna 402. In other words, the near-field power antenna 402 delivers electrical energy to the near-field receiver antenna 404 without physical connections (e.g., wires). The energy transfer, or delivery, occurs through electromagnetic fields, for example via magnetic induction or magnetically coupled resonance.

For example, an alternating current (AC) flows through the near-field power antenna 402, generating a time-varying magnetic field. When the near-field receiver antenna 404 is positioned within said field (e.g., the door 116 being in the closed position), a voltage is induced in the near-field receiver antenna 404, allowing electrical energy to be transferred.

The near-field receiver antenna 404, similar to the near-field power antenna 402, may include, for example, a generally planar, spiral-shaped conductive trace on a printed circuit board (PCB) or flexible substrate. The conductive trace may include, for example, copper or other highly conductive material. The near-field receiver antenna 404 is tuned to receive the oscillating magnetic field within a range of about 6.8 MHz to about 13.6 MHz.

“Tuning” the near-field power antenna 404 refers to the process of matching the resonant frequency of the near-field receiver antenna 404 to that of the near-field power antenna 402, for example, to maximize power transfer efficiency. The near-field receiver antenna 404 may have an inductance and a capacitor to create a resonant LC circuit, for example. The resonant frequency is determined by the formula

$${f}_{0} = \frac{1}{2 π \sqrt{LC}}$$

where L is the inductance of the coil, or near-field receiver antenna 404, and C is the capacitance of the capacitor.

In addition to frequency matching, “tuning” may include impedance matching. An impedance of the near-field power antenna 404 may be about equal to an input impedance of a rectifier, or power conversion circuit. “Tuning” may also include load optimization, ensuring the near-field antenna 404 is equipped for the expected electrical load, such as a charging circuit. “Tuning” may further include adjusting a capacitor value or modifying a geometry of the coil. The techniques related to tuning are not limited to the techniques mentioned herein, as is generally understood by one ordinary skill in the art.

The near-field receiver antenna 404, similar to the near-field power antenna 402, has a second central axis 408. The near-field receiver antenna 404 also has a second diameter D2 centered about the second central axis 408. Further, the near-field receiver antenna 404 includes a second plurality of magnets 412 respectively spaced from the second central axis 408 by a second distance S2. The second distance S2 is at least as great as the second diameter D2. In other words, the second distance S2 is at least equal to the second diameter D2 of the near-field receiver antenna 404.

The second plurality of magnets 412 may include a third magnet 426 and a fourth magnet 428 spaced from the third magnet 426 by at least twice the second distance S2 across the second central axis 408. Additionally, or alternatively, the fourth magnet 428 may be positioned about 180 degrees away from the third magnet 426 about the second central axis 408. Therefore, the fourth magnet 428 may be positioned diametrically opposite the third magnet 426 about the second central axis 408.

Each magnet of the second plurality of magnets 412 (e.g., the third magnet 426 and the fourth magnet 428) has a north end and a south end. For example, the third magnet 426 has a third north end 432 and a third south end 430. The fourth magnet 428 has a fourth north end 436 and a fourth south end 434. Like ends repel and non-like ends attract (e.g., a north end repels a different north end and a north end attracts a south end).

The door 116 in the closed position allows the near-field power antenna 402 to be spaced from the near-field receiver antenna 404 close enough to charge the near-field receiver antenna 404. For example, in operation, the near-field receiver antenna 404 may be spaced from the near-field power antenna 402 by less than about 1 cm, by less than about 0.5 cm, or by less than about 0.2 cm in the transverse direction T.

The door 116 in the closed position allows the first plurality of magnets 410 to magnetically interact with the second plurality of magnets 412. The north ends (e.g., the first north end 418 and the second north end 422) of the first plurality of magnets 410 may be oriented toward the second plurality of magnets 412. Additionally, or alternatively, the south ends (e.g., the first south end 420 and the second south end 424) of the first plurality of magnets 410 may be oriented toward the second plurality of magnets 412. The south ends (e.g., the third south end 430 and the fourth south end 434) of the second plurality of magnets 412 are oriented toward the first plurality of magnets 410 if the north ends of the first plurality of magnets 410 are oriented toward the second plurality of magnets 412. Additionally, or alternatively, the north ends (e.g., the third north end 432 and the fourth north end 436) of the second plurality of magnets 412 are oriented toward the first plurality of magnets 410 if the south ends of the first plurality of magnets 410 are oriented toward the second plurality of magnets 412. Accordingly, the door 116 in the closed position allows the first plurality of magnets 410 to magnetically attract the second plurality of magnets 412, and the second plurality of magnets 412 to magnetically attract the first plurality of magnets 410.

With continued reference to the body 446 of the dispenser assembly 400, the first plurality of magnets 410 and the second plurality of magnets 412 that are magnetically interacting may move the body 446 such that the second central axis 408 of the near-field receiver antenna 404 is aligned with the first central axis 406 of the near-field power antenna 402 along a common axis A. Additionally, or alternatively, the first plurality of magnets 410 and the second plurality of magnets 412 that are magnetically interacting may move the near-field power antenna 402 such that the second central axis 408 of the near-field receiver antenna 404 is aligned with the first central axis 406 of the near-field power antenna 402 along the common axis A. The common axis A, may extend along the transverse direction T, as illustrated in the examples of the figures.

Aligning the first central axis 406 with the second central axis 408 with the door 116 in the closed position allows for a more efficient transfer of power from the near-field power antenna 402 to the near-field receiver antenna 404 compared to the central axes 406, 408 of the antennas 402, 404 not being aligned at the common axis A.

The dispenser assembly 400 may include a reservoir 448 configured to store a wash additive, or detergent. Charging the near-field receiver antenna 404 with the near-field power antenna 402 may allow the dispenser assembly to dispense additive from the reservoir 448 into the wash chamber 106. The additive may be dispensed through a nozzle 450, for example. Additionally, or alternatively, the dispenser assembly 400 may include a valve (not shown) communicatively coupled with the controller 160 via the near-field power antenna 402 and the near-field receiver antenna 404, such that the valve open to release the additive based, at least in part, on the near-field power antenna 402 charging the near-field receiver antenna 404.

According to this disclosure, a dispenser assembly may be provided with a near-field power antenna and a near-field receiver antenna. The near-field power antenna and the near-field receiver antenna may each include a plurality of magnets that operably align the near-field power antenna and the near-field receiver antenna. The plurality of magnets are spaced from a central axis of each antenna, respectively, by at least a distance equal to a diameter of each antenna.

Advantageously, the plurality of magnets allow the near-field power antenna and the near-field receiver antenna to align at a common axis for more efficient power transfer. Further, it is advantageous to space the plurality of magnets from each near-field antenna to prevent attenuation or even to prevent the near-field antennas from short circuiting. For example, the PCB of each near-field antenna may short circuit if the plurality of magnets were positioned closer to the near-field antennas than the first distance or the second distance, respectively. The arrangement of each and every element described herein allows for a more efficient transfer of power from the near-field power antenna to the near-field receiver antenna.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwashing appliance defining transverse direction, a lateral direction, and a vertical direction, the dishwashing appliance comprising:
a tub defining a wash chamber for receipt of articles for washing;
a door movable between a closed position and an open position; and
a dispenser assembly partially mounted to the door and partially disposed within the wash chamber, the dispenser assembly comprising:
a near-field power antenna coupled with the door, the near-field power antenna having:
a first central axis; and
a first diameter about the first central axis;
a first plurality of magnets spaced from the first central axis of the near-field power antenna by a first distance, wherein the first distance is at least equal to the first diameter of the near-field power antenna;
a near-field receiver antenna disposed within the wash chamber, the near-field receiver antenna having:
a second central axis; and
a second diameter about the second central axis; and
a second plurality of magnets spaced from the second central axis of the near-field receiver antenna by a second distance, wherein the second distance is at least equal to the second diameter of the near-field receiver antenna.

2. The dishwashing appliance of claim 1, wherein the second plurality of magnets operably align with the first plurality of magnets such that the first central axis aligns with the second central axis about a common axis to increase efficiency of a transfer of power from the near-field power antenna to the near-field receiver antenna.

3. The dishwashing appliance of claim 1, wherein the first plurality of magnets comprises:
a first magnet; and
a second magnet positioned about diametrically opposite the first magnet across the first central axis, wherein the second magnet is spaced from the first magnet by the first distance.

4. The dishwashing appliance of claim 3, wherein the second plurality of magnets comprises:
a third magnet; and
a fourth magnet positioned about diametrically opposite the first magnet across the second central axis, wherein the fourth magnet is spaced from the second magnet by the second distance.

5. The dishwashing appliance of claim 4, wherein the first magnet is positioned about 180 degrees away from the second magnet about the first central axis, and wherein the third magnet is spaced about 180 degrees from the fourth magnet about the second central axis.

6. The dishwashing appliance of claim 1, wherein the first distance is about equal to the second distance, and wherein each magnet of the first plurality of magnets has a first north end and a first south end.

7. The dishwashing appliance of claim 6, wherein each of the second plurality of magnets has a second north end and a second south end, wherein each of the of the second plurality of magnets are oriented to be attracted to the first plurality of magnets, respectively.

8. The dishwashing appliance of claim 1, wherein at least one of the near-field power antenna or the near-field receiver antenna is configured to move via a magnetic attraction at least one of the near-field power antenna or the near-field receiver antenna to couple the near-field power antenna and the near-field receiver antenna.

9. The dishwashing appliance of claim 8, further comprising a rack disposed within the wash chamber, wherein the dispenser assembly is partially coupled with the rack.

10. The dishwashing appliance of claim 9, wherein at least one of the near-field power antenna or the near-field receiver antenna is configured to move relative to the rack via a magnetic attraction between the near-field power antenna and the near-field receiver antenna.

11. The dishwashing appliance of claim 1, wherein the near-field power antenna charges the near-field receiver antenna to power the dispenser assembly.

12. The dishwashing appliance of claim 11, wherein the dispenser assembly includes a reservoir for a wash additive, and wherein the dispenser assembly that is powered is configured to release the wash additive.

13. The dishwashing appliance of claim 12, further comprising a controller selectively and communicatively coupled with the dispenser assembly via the near-field power antenna aligned with the near-field receiver antenna.

14. The dishwashing appliance of claim 13, wherein the controller is configured to instruct the dispenser assembly to release the wash additive.

15. A dispenser assembly defining a transverse direction, a lateral direction, and a vertical direction, the dispenser assembly comprising:
a body;
a near-field power antenna selectively positioned adjacent to the body, the near-field power antenna having:
a first central axis; and
a first diameter about the first central axis;
a first plurality of magnets spaced from the first central axis of the near-field power antenna by a first distance, wherein the first distance is at least equal to the first diameter of the near-field power antenna;
a near-field receiver antenna coupled with the body, the near-field receiver antenna having:
a second central axis; and
a second diameter about the second central axis; and
a second plurality of magnets spaced from the second central axis of the near-field receiver antenna by a second distance, wherein the second distance is at least equal to the second diameter of the near-field receiver antenna.

16. The dispenser assembly of claim 15, wherein the second plurality of magnets operably align with the first plurality of magnets such that the first central axis aligns with the second central axis about a common axis to increase efficiency of a transfer of power from the near-field power antenna to the near-field receiver antenna.

17. The dispenser assembly of claim 15, wherein the first plurality of magnets comprises:
a first magnet; and
a second magnet positioned about diametrically opposite the first magnet across the first central axis, wherein the second magnet is spaced from the first magnet by the first distance.

18. The dispenser assembly of claim 17, wherein the second plurality of magnets comprises:
a third magnet; and
a fourth magnet positioned about diametrically opposite the first magnet across the second central axis, wherein the fourth magnet is spaced from the second magnet by the second distance.

19. The dispenser assembly of claim 15, wherein at least one of the near-field power antenna or the near-field receiver antenna is configured to move via a magnetic attraction at least one of the near-field power antenna or the near-field receiver antenna to couple the near-field power antenna and the near-field receiver antenna.

20. The dispenser assembly of claim 15, wherein the dispenser assembly includes a reservoir for a wash additive, and wherein the dispenser assembly that is powered is configured to release the wash additive.
